(19) United States
(12) Patent Application Publication
(10) Pub. No.: US 2006/0231355 A1
(43) Pub. Date: Oct. 19, 2006

(54) Railway wheel with integrated brake drum

(76) Inventor: Ming (Jason) Zhang, Montreal (CA)

Correspondence Address: Ming (Jason) Zhang, 5270 Rosedale Avenue, Montreal, QC, H4V 2H6, CA

(21) Appl. No.: 11/107,266

(22) Filed: Apr. 18, 2005

(51) Int. Cl. F16D 65/10

(52) U.S. Cl. 188/218 R

(57) ABSTRACT

The present invention provides novel railway wheel configurations with integrated brake drum dedicated to vehicle frictional braking, along with manufacturing method of the novel wheel and modification schemes for existing railway vehicle components. The novel wheel configurations with integrated brake drum improve thermal tolerances to brake shoe thermal input, enhances resistances to various thermal damages and increases effective thermal capacity of railway wheel used as a frictional brake component.

### 1. CROSS REFERENCE TO RELATED APPLICATIONS

Not Available.

### 2. TECHNICAL FIELD

The present invention relates generally to methods and apparatus for frictional braking of a vehicle or other heavy machinery. In particular, the present invention relates to novel railway wheel configuration that provides integrated brake drum dedicated to railway vehicle frictional braking.

### 3. BACKGROUND OF THE INVENTION

Railway wheels mounted to freight car serves as not only a mechanical supporting component guiding rail car along the rail, but also a brake drum generating sufficient brake torque to stop the train and dissipating rapidly brake heat for safe train operation.

It has been recognized that railway wheels suffer from various types of wheel thermal damages due to brake heat produced in the tread, and internal stresses of expansion (tensile) and contraction (compressive) developed in the wheel caused by the brake heat input, the wheel thermal damages including,
1. Thermal fatigue cracking on wheel tread surface due to localized stress reversal from the as-manufactured residual compressive hoop stress to tensile stresses;
2. Thermal failure due to, in wheel rim, complete reversal from beneficial compressive residual hoop stresses left by the manufacturing process to tensile stresses, and in wheel plate, development of strong tensile hoop stresses;
3. Thermal-mechanical shelling due to combined elevated tread temperature and high rolling contact stresses;
4. Wheel spalling resulted from formation of brittle martensite during wheel slides and from subsequent fracture and cracking propagation under combined high wheel/rail rolling contact stresses and high temperatures;
5. Built up tread (out of round) due to thermal deformation of wheel that can induce high impact damages to wheel, wheel set, rail car and lading.

Recent studies also suggested that under heavier braking, brake heat, referring also as brake shoe thermal input, may accelerate the growth of shattered rim fracture, a phenomenon whereby rolling contact fatigue crack initiates at an internal defect in the wheel rim subsurface and propagates rapidly to cause a sudden substantial damage to the wheel.

Brake shoe thermal input also causes damaging hot axial deflection of wheel flange that could introduce large variations in rail/wheel flange clearances at elevated temperature and subsequent normal operation. Such variations could impair dynamic performance and safety of rail car under extreme service conditions.

Through predominately abrasive wear at high temperatures, wheel tread braking contributes to uneven wear of wheel tread and helps accelerate the formation of hollow wheel tread and high flange. The accelerated wear and subsequent wheel truing shortens significantly normal wheel service life.

It can be easily noticed that the configuration of railway wheel of prior arts requires sharing of a single wheel tread surface by engaging-rail all the times and by engaging-brake-shoe during tread braking.

The direct brake shoe thermal input makes the wheel tread hottest region in the wheel while the rail/wheel rolling contact or impact makes the same wheel tread highest stressed region in the wheel. Since the properties of the wheel tread material degrades significant at high temperatures, such overlap of high stress and high temperature and its combined effects make the wheel tread extremely vulnerable to the above-mentioned thermal wheel damages.

Despite all the above mentioned problems, wheel tread braking does offer a lot of advantages compared with alternative disc braking system and is widely used in various railway vehicles, the advantages including:
1. Simple, robust and low-cost brake system that can be easily maintained;
2. Space-saving and weight-saving rolling stock arrangement requiring no additional brake disc or brake disc hub;
3. Simple, robust and low-cost brake shoes that are easily replaceable.

With present demands of increasing rail car load, increasing car running speed and improving operational reliability/efficiency, railway wheels are expected to withstand more thermal and mechanical load while providing longer service lives without sacrificing safety and overall maintainability of rail cars.

Accordingly, what is needed in the art are new wheel configurations that offer greater thermal tolerance to brake shoe thermal input, increased thermal capacity, and enhanced resistances to various types of thermal damages.

For the possibility of wide application to the existing rail cars and to the existing railway networks, the newly developed wheel configurations must also comply with the North American standards and/or European standards in terms of wheel profiles, maximum hot axial deflection and maximum thermal stresses during tread braking.

The applicant's invention is a substantial departure from conventional railway wheels, and the applicant is not aware of any prior art having a similar railway wheel configuration similar to his.

### 4. SUMMARY OF THE INVENTION

One object of the present invention is to provide novel wheel configurations with integrated brake drum that remains substantially contact-free with rail and is dedicated to railway vehicle frictional braking. Such wheel configurations are invented aiming at increasing thermal capacity, improving thermal tolerance and enhancing thermal damage resistances of the wheel.

Another object of the present invention is to provide above-mentioned novel wheel configurations that permit easy wheel manufacture by conventional processes and easy wheel application to the existing railway vehicle and railway environment requiring minimum modification to the present vehicle components and railway infrastructure.

Another object of the present invention is to provide new tread braking methods for taking full advantage of novel wheel configuration in terms of increasing service life of freight rail car or increasing braking power of high speed passenger train.

Another object of the present invention is to provide conversion methods for the existing standard rail car braking components allowing application novel wheels to the existing rail cars.

Other objects and advantages of the present invention can become more apparent to those skilled in the art as the nature of the invention is better understood from the accompanying drawings, as well as detailed descriptions.

### 5. BRIEF DESCRIPTION OF THE DRAWINGS

FIG. 1 is a partial top view of a standard rail car truck that exemplifies the prior art, including a standard railway wheel set and a wheel tread braking system.

FIG. 1A is a partial cross sectional view of the apparatus depicted in FIG. 1 taken along the line 1A-1A, showing a standard railway wheel being engaged with a brake shoe.

FIG. 1B is a partial cross sectional view of the standard railway wheel and the engaging-brake-shoe depicted in FIG. 1A, taken along the line 1B-1B.

FIG. 2 is a partial cross sectional view of one embodiment of the present invention.

### 6. DETAILED DESCRIPTION OF THE DRAWINGS

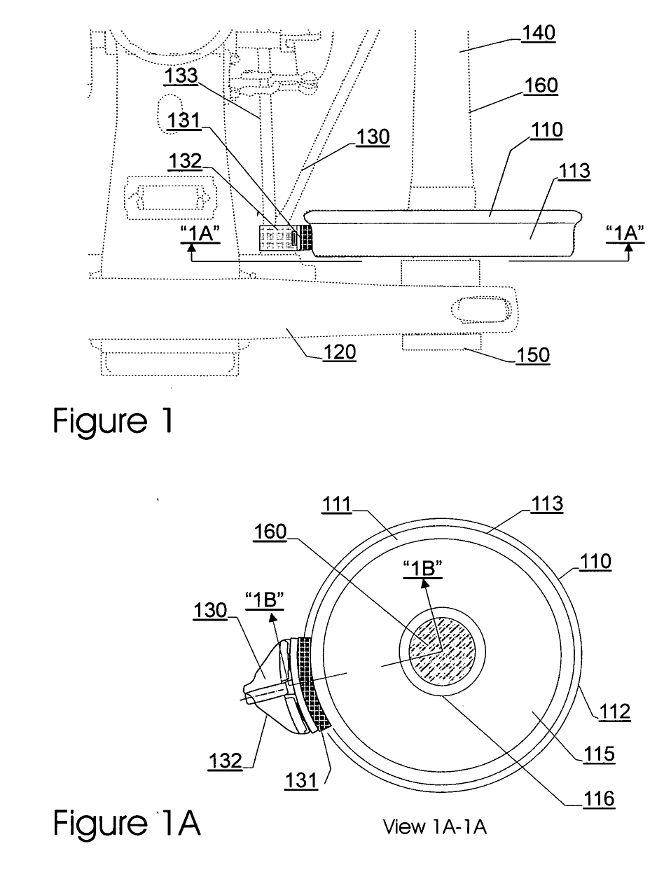

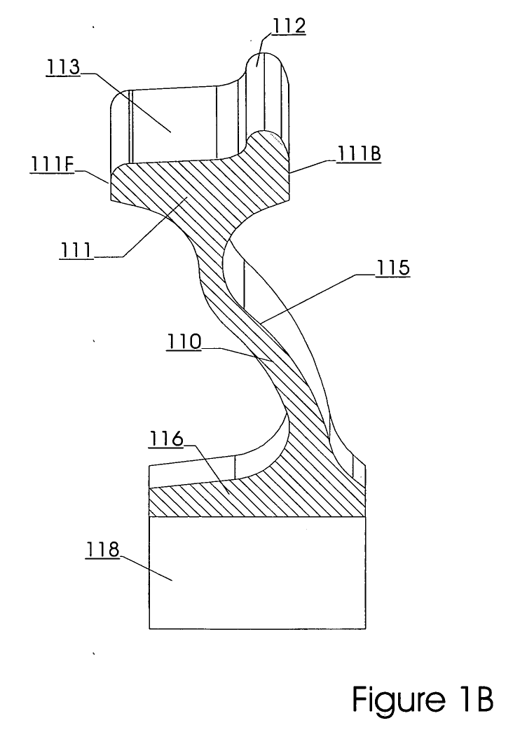

Referring to FIG. 1, FIG. 1A and FIG. 1B, a conventional rail car truck 120 that is typical of the prior art is provided showing a wheel set assembly 140 and a tread brake system 130 in particular.

The wheel set assembly 140 consists of a pair of wheels 110 and roller bearings 150 that are mounted on opposite ends of an axle 160. The tread brake system 130 consists of a brake beam 133 activated by an air brake control system, a pair of brake shoe holders 132 mounted near opposite ends of the brake beam 133 and a pair of brake shoes 131 mounted to the brake shoe holders 132. The pair of brake shoe holder 132 is positioned on the brake beam in a way that assures proper brake shoe/wheel tread engagement during tread braking.

As best shown in FIG. 1B, each wheel 110 is provided with an annular wheel rim 111, an annular wheel hub 116, and a substantially radially extended wheel plate 115 that connects integrally the wheel rim 111 and the wheel hub 116. Each wheel rim 111 has two sides, a front side 111F that faces outward once mounted on the axle 160 and a back side 111B that faces inward to another wheel once mounted on the axle 160. Each wheel is provided with a flange 112 that is protruded radially outward from the wheel rim 111 near the back side 111B.

The outer periphery of the wheel rim 111 forms a wheel tread 113 that rolls on rail track all the times and is engaged with brake shoe 131 substantially radially during tread braking. The essentially cylindrical shaped inner periphery of the wheel hub 116 forms a wheel bore 118 that is created at the center of the wheel hub 116 for mounting to the axle 116. The wheel flanges 112 of the pair of wheels 110 mounted on the same axle 160 help guiding/steering the rail car truck 120 on rail track.

Under combined mechanical and thermal loading during tread braking, the wheel 110 suffers accelerated uneven wear and subjects to severe damages on the tread 113. The worn out or damaged tread causes unfavorable rail car running conditions such as severe vibration, high impacts, poor curving performance that will lead to severe damages to the rail car components as well as rail track. It is a common practice to recondition periodically the wheel tread by re-machining which will shorten significantly wheel service lives.

It is also known that the heated wheel rim 111 during tread braking tries to expand radially and is constrained by the colder wheel plate 115 and the even colder wheel hub 116, thereby creating strong internal tensile hoop stresses in the wheel rim 111 and wheel plate 115, generating strong bending stress in the wheel plate 115 and causing hot axial deflection of the wheel flange 112. The tensile hoop stress in the wheel plate 115 is resisted by the beneficial compressive residual stresses developed in the wheel rim 111 produced by the heat treatment during wheel manufacture. However, the residual stress reversal, either locally or generally, from beneficial compressive hoop stress to tensile hoop stress could occur in the wheel rim 111 under heavy tread braking, leading to catastrophic wheel failures.

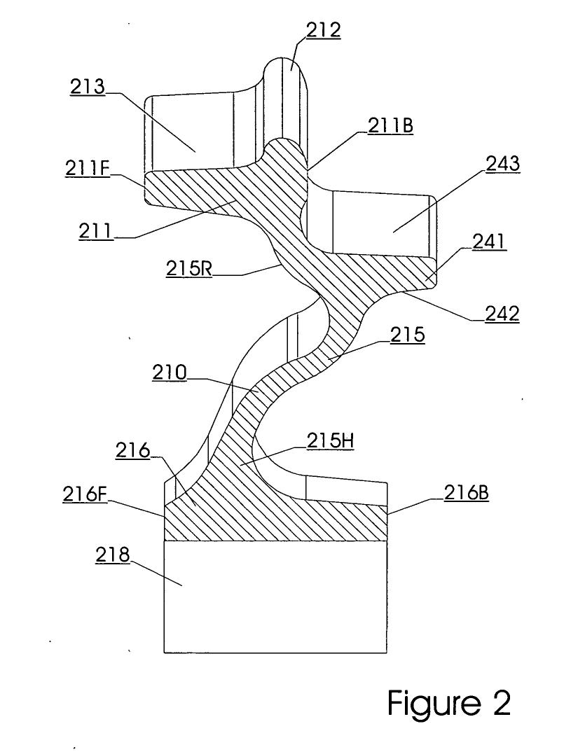

Referring to FIG. 2, one novel wheel configuration 210 of the present invention is shown in a similar manner as the wheel 110 in FIG. 1B. The wheel 210 differs substantially from the wheel 110 mainly in the cross sectional profile.

The wheel 210 provides an additional brake drum 241 that protrudes from the backside of the wheel plate 215, defining a substantially axially extended outer peripheral surface 243 and inner peripheral surface 242. The brake drum 241 is substantially adjacent to the wheel rim 211 and relatively far away from the wheel hub 216.

The outer peripheral surface 243 of the brake drum 241 is tapered similarly to the wheel tread 213 that is favorable for both proper functioning and easy manufacture of the novel wheel 210.

In order to accommodate the existing railway infrastructure and avoids potential interference with the existing railway track works such as frogs, guard rails and crossing etc, the outer peripheral surface 243 of the drum 241 is kept to a smaller diameter relative to the wheel tread 213.

The wheel plate 215 between the wheel rim 211 and the wheel hub 216 takes an essentially a bell shaped profile while the portion 215H of the wheel plate 215 between the added drum 241 and the wheel hub 216 takes an essentially a S-curved shape. The portion 215H of the wheel plate joins to the brake drum 241 in proximity of the middle of the inner peripheral surface 242 of the brake drum 241 and joins to the wheel hub 216 in proximity of its front face 216F. Such arrangements are made for the purpose of minimizing thermal stresses in the plate 215, minimizing hot axial deflection of the wheel flange 212 and allowing easy manufacture of the wheel 210.

The portion 215R of wheel plate 215 between the wheel rim 211 and the drum 214 has a substantially thicker cross section for the purpose of promoting rapid heat transfer and reducing hot axial deflection of the wheel flange.

The wheel 210 can be manufactured by any suitable conventional manufacturing processes including but not limited to forging, casting, machining or any combinations of the above-mentioned processes. The brake drum 241 is formed integrally with the wheel 210 during the wheel manufacturing process.

The wheel 210 is also subjected to similar heat treatment, shot peening, non destructive testing (NDT), chemical and physical analysis and dimensional inspections as the wheels 110 do during the wheel manufacture. Consequently, similar quality and similar level of compressive residual stresses are developed in the wheel rim 211 as well as in the integrated brake drum 241, which are beneficial for resisting wheel fatigue and thermal wheel failures.

The wheel 210 is made of any suitable material including but not limited to carbon steel, alloy steel, other metal alloys or metal composites.

The novel wheel 210 of the present invention can be used with most of the existing freight rail car components with minor modification. In particular, the novel wheel 210 permits the use of conventional wheel tread braking means that is similar to the arrangement shown in FIG. 1. With relocation of the pair of brake shoe holders mounted on opposite end of brake beam to a closer relative position, an existing tread braking means can be easily converted to accommodate the use of novel wheel in an existing standard rail car.

The addition of the integrated brake drum 241 allows the novel wheel 210 to be used in several different manners, one being a single braking scheme having braking elements engaged only with the brake drum 241, and the others being a dual or multiple brake schemes having the braking elements engaged with, in addition to the brake drum 241, the tread 213 or the surface of the flange 212 at the same time.

The single braking scheme avoids direct brake shoe thermal input into the wheel tread 213 and provides additional thermal masses in a relatively thin-walled geometry favorable for efficient air cooling. The altered wheel geometry combined with altered heat input location, lowers the local temperature of the wheel tread 213 and of the wheel rim 211, lowers the overall stress state in the wheel rim 211 as well as in the wheel plate 215. The wheel tread will never be exposed to instant flash high temperature that could reach more than 800 C therefore greatly reduced the risk of potential wheel tread thermal damages. All these changes contribute to greater thermal tolerance of the wheel 210 to brake shoe thermal inputs and greater resistances to the wheel thermal damages when compared to the wheel 110 of the prior art.

The dual or multiple brake schemes, on the other hand, makes sharing of the same thermal load among the additional brake drum 241, wheel tread 213 and the wheel flange 212. Those dual or multiple brake schemes reduce the heat input intensity on the wheel tread 213 and on the peripheral surface 243 of the additional brake drum 241, and reduces hot axial deflection of the wheel flange 212.

The above-mentioned dual heat input schemes can well be used in both heavy haul freight car application and high speed passenger car applications. They have potentials to replace larger diameter wheel in the more demanding heavy haul freight car applications allowing design and use of smaller and lighter freight car truck. Meanwhile they also have the potentials to replace or use as an extra high energy brake disc that is used currently in the high speed train.

Furthermore, the application of the novel wheel 210 allows the possibility of having an extra abrasive elements be disposed to engage periodically with the wheel tread 211 for the purpose of reconditioning the wheel tread profile and removing already initiated fatigue cracks from the wheel tread.

### 7. OTHER GENERAL REMARKS

1. The wheel plate 215 may take any other suitable cross sectional profiles and the plate 215 may join the hub 216, brake drum 214 and the wheel rim 211 at different longitudinal locations for the purpose of minimizing temperature on the wheel tread 213, minimizing thermal stresses in the plate 215, minimizing hot axial deflection of the wheel flange 212 and allowing easy manufacture of the wheel 210.
2. The added drum 214 may be formed either on the front side or on the backside of the wheel 210 with any suitable dimensions. The possible diametrical position for the added drum 214 may be anywhere along either side of the wheel including the end faces 211F and 211B of the rim 211, both sides of the wheel plate 215 and the end faces 216F and 216B of the hub 216.
3. While the present invention is illustrated and described based on an integrally formed wheel structure with integrated brake drum, it is to be understood that the present invention is also applicable for use with other wheel configurations that allows separate brake drum be attached to wheel rim therefore making the brake drum replaceable during service life of the wheel.
4. Present tread brake system can be easily altered so that brake shoe engages with inner peripheral surface of brake drum instead of outer peripheral surface, or engages with both surfaces of the brake drum.
5. Non brake shoe engaging surface of the brake drum, for example inner surface 242 of the brake drum 241 can be formed in a corrugated, grooved or threaded geometry for the purpose of promoting effective air cooling.
6. While the novel wheel and other modified auxiliary components is configured for rail car application, it is to be understood that the present invention is also be applicable for use with other types of ground transportation vehicle or heavy machinery.
   Other advantages of the present invention will become more fully apparent and understood with reference to the appended drawings and claims.

What is claimed is:

1. A railway wheel for use with a railway vehicle brake mechanism, each said wheel comprising:
a hub with an axial bore;
an axially elongated annular tread defining a rim being generally concentric with said bore, said tread being engaged with a rail when the railway vehicle is in operation;
a plate extending generally radially outward from said hub to said rim;
a flange projecting radially outward from said rim near one edge of said rim, thereby defining backside of the wheel with said flange and front side of the wheel without said flange;
and at least one annular and generally axially elongated brake drum being disposed by either side of the wheel, said brake drum being generally concentric with said bore and remaining substantially contact-free with said rail when the railway vehicle is in operation;
said railway vehicle brake mechanism provided for each said wheel comprising:
brake elements;
a brake-element-engaging means that carries said brake elements and operable to engage brake elements with the peripheral surface of said wheel to brake rotation of said wheel thereby defining brake-element-engaged wheel surface;
said brake-element-engaged wheel surface including at least partially the peripheral surface of said brake drum, thereby dividing the peripheral surface of said brake drum into engaged drum surface and unengaged drum surface.

2. The railway wheel for use with the railway vehicle brake mechanism as recited in claim 1, wherein said wheel is an integrally formed structure and the brake drum is a protrusion from the plate or a protrusion from the rim.

3. The railway wheel for use with the railway vehicle brake mechanism as recited in claim 2, wherein
the brake drum is a protrusion from the backside of the plate of said wheel, thereby defining an outer annular portion of the plate located between the brake drum and the rim of said wheel and an inner annular portion of the plate located between the brake drum and the hub of said wheel,
the outer peripheral surface of the brake drum has a smaller diameter than the tread of said wheel.

4. The railway wheel for use with the railway vehicle brake mechanism as recited in claim 3, wherein
the outer annular portion of the plate of said wheel is substantially thicker than the inner annular portion of the plate;
the inner annular portion of the plate of said wheel has a curved cross sectional profile;
the inner annular portion of the plate joins to the brake drum in the proximity of the middle of the inner peripheral surface of the brake drum.

5. The railway wheel for use with the railway vehicle brake mechanism as recited in claim 1, wherein the engaged drum surface is within the outer peripheral surface of the brake drum and the brake element is applied substantially radially to the engaged drum surface.

6. The railway wheel for use with the railway vehicle brake mechanism as recited in claim 1, wherein the brake-element-engaged wheel surface includes, in addition to the engaged drum surface, a portion of the flange surface of said wheel or a portion of the tread of said wheel.

7. A method for improving performance and reliability of a railway wheel being used as a frictional brake component in a railway vehicle, the method comprising,
forming said railway wheel that comprises,
a hub with an axial bore;
an axially elongated annular tread defining a rim being generally concentric with said bore, said tread being engaged with a rail when the railway vehicle is in operation;
a plate extending generally radially outward from said hub to said rim;
a flange projecting radially outward from said rim near one edge of said rim, thereby defining backside of the wheel with said flange and front side of the wheel without said flange;
and at least one annular and generally axially elongated brake drum being disposed by either side of the wheel, said brake drum being generally concentric with said bore and remaining substantially contact-free with said rail when the railway vehicle is in operation;
providing a railway vehicle brake mechanism to be used with said wheel, said railway vehicle brake mechanism comprising,
brake elements;
a brake-element-engaging means that carries said brake elements and operable to engage brake elements with the peripheral surface of said wheel to brake rotation of said wheel thereby defining brake-element-engaged wheel surface;
said brake-element-engaged wheel surface including at least partially the peripheral surface of said brake drum, thereby dividing the peripheral surface of said brake drum into engaged drum surface and unengaged drum surface.

8. The method for improving performance and reliability of a railway wheel being used as a frictional brake component in a railway vehicle, as recited in claim 7, wherein the wheel is integrally formed as one structure and the brake drum is a protrusion from the plate or a protrusion from the rim.

9. The method for improving performance and reliability of a railway wheel being used as a frictional brake component in a railway vehicle, as recited in claim 8, wherein the brake drum is a protrusion from the backside of the plate of said wheel, thereby defining an outer annular portion of the plate located between the brake drum and the rim of said wheel and an inner annular portion of the plate located between the brake drum and the hub of said wheel,
the outer peripheral surface of the brake drum has a smaller diameter than the tread of said wheel.

10. The method for improving performance and reliability of a railway wheel being used as a frictional brake component in a railway vehicle, as recited in claim 9,
the outer annular portion of the plate of said wheel is substantially thicker than the inner annular portion of the plate;
the inner annular portion of the plate of said wheel has a curved cross sectional profile;
the inner annular portion of the plate joins to the brake drum in the proximity of the middle of the inner peripheral surface of the brake drum.

11. The method for improving performance and reliability of a railway wheel being used as a frictional brake component in a railway vehicle, as recited in claim 7, wherein the engaged drum surface is within the outer peripheral surface of the brake drum and the brake element is applied substantially radially to the engaged drum surface.

12. The method for improving performance and reliability of a railway wheel being used as a frictional brake component in a railway vehicle, as recited in claim 7, wherein the brake-element-engaged wheel surface includes, in addition to the engaged drum surface, a portion of the flange surface of said wheel or a portion of the tread of said wheel.

13. The method for improving performance and reliability of a railway wheel being used as a frictional brake component in a railway vehicle, as recited in claim 7, wherein the brake-element-engaging means is a converted-railway-tread-braking means that carries said brake elements and operable to engage at least one of said brake elements with the engaged drum surface, said converted-railway-tread-braking means is converted from a conventional railway-tread-braking means that engages said braking elements only to the tread of said wheel.

14. The method for improving performance and reliability of a railway wheel being used as a frictional brake component in a railway vehicle, as recited in claim 7, wherein the railway vehicle brake mechanism comprises an additional abrasive element that is operable to engage with the tread of said wheel for the purpose of reconditioning the tread.
